(19) United States
(12) Patent Application Publication
(10) Pub. No.: US 2012/0284098 A1
(43) Pub. Date: Nov. 8, 2012

(54) PROCESSING CROSS-LINE CONVERSIONS

(75) Inventor: Brian Bouta, Santa Clara, CA (US)

(73) Assignee: Yahoo! Inc., Sunnyvale, CA (US)

(21) Appl. No.: 13/101,708

(22) Filed: May 5, 2011

(51) Int. Cl. G06Q 30/00

(52) U.S. Cl. 705/14.16; 705/14.34

(57) ABSTRACT

Techniques are described herein for processing cross-line conversions. A cross-line conversion occurs when a user performs an offline acceptance of an offer that is associated with an online advertisement. An offline acceptance is an acceptance that is made in-person by the user at a physical location of a seller. Examples of such a physical location include but are not limited to a retail store (e.g., a department store or a boutique store), a fixed or mobile retail stand, a booth at a conference (e.g., a business conference or an academic conference), a kiosk, a sporting arena, a ball park, etc.

### BACKGROUND OF THE INVENTION

1. Field of the Invention

The present invention relates to online advertising.

2. Background

Certain advertisement (“ad”) networks enable ads (e.g., contextual ads, display ads) to be served to users who visit the Web sites of publishers that are participating in the ad network. Advertisers generate the ads and buy placements (a.k.a. inventory) for those ads on the publishers' Web sites usually based on the anticipated audiences for those sites and/or the content of those sites. These ads may be graphical (“display ads”) or textual. A placement represents a publisher's agreement to serve a trafficked (i.e., specified) ad to users when the users visit the publisher's site. The publisher often serves the trafficked display or contextual ad contemporaneously with other content associated with the publisher's site. Similarly, sponsored search advertising systems serve ads (“sponsored ads”) to users that enter queries on search engine Web sites, often alongside the responses to the queries.

Ad networks typically include ad serving systems that determine which advertisements are to be provided to users. In conventional contextual or display ad networks, when a publisher receives a page view from a user, the publisher sends an ad call to an ad serving system. An ad call is a request for an advertisement. The ad serving system selects an advertisement from an ad inventory based on various factors. The query that is used by the ad serving system to select the advertisement depends on the configuration of the ad serving system. The ad serving system then sends the advertisement to the publisher, so that the publisher can serve the advertisement to the user. Sponsored search advertising systems work similarly. When the search engine receives a query from the user, an ad call is sent to the ad serving system, which typically selects an advertisement based on that query.

Advertisements that are provided to users often include offers for discounts on purchase prices of products (or services) of sellers. The users can present the offers to the sellers to have the purchase prices reduced by the amount of the discounts at the time of purchase. However, conventional ad serving systems typically do not provide incentives or technical means for sellers to attribute such sales to an operator of the ad serving system, to provide information regarding such sales to the ad serving system, etc.

### BRIEF SUMMARY OF THE INVENTION

Various approaches are described herein for, among other things, processing cross-line conversions. A cross-line conversion occurs when a user performs an offline acceptance of an offer that is associated with an online advertisement. An offline acceptance is an acceptance that is made in-person by the user at a physical location of a seller.

An example method is described in which an online ad is provided that specifies an offer for a rebate of a portion of a purchase price that is associated with a product and/or service of a seller in return for a purchase of the product and/or service. An indication of an offline acceptance of the offer by a user is received. The seller is charged for an amount of the rebate. The amount of the rebate is credited to the user. A payment is received from the seller as compensation for facilitating a cross-line conversion of the offer to the offline acceptance.

An example system is described that includes an ad provision module, an acceptance module, a charging module, and a credit module. The ad provision module is configured to provide an online ad that specifies an offer for a rebate of a portion of a purchase price that is associated with a product and/or service of a seller in return for a purchase of the product and/or service. The acceptance module is configured to interpret an acceptance indicator that indicates an offline acceptance of the offer by a user. The charging module is configured to charge the seller for an amount of the rebate in response to interpretation of the acceptance indicator. The charging module is further configured to charge the seller a fee for facilitation of a cross-line conversion of the offer to the offline acceptance. The credit module is configured to credit the amount of the rebate to the user in response to the interpretation of the acceptance indicator.

An example computer program product is described that includes a computer-readable medium having computer program logic recorded thereon for enabling a processor-based system to perform processing with regard to a cross-line conversion. The computer program logic includes first, second, third, and fourth program logic modules. The first program logic module is for enabling the processor-based system to provide an online ad that specifies an offer for a rebate of a portion of a purchase price that is associated with a product and/or service of a seller in return for a purchase of the product and/or service. The second program logic module is for enabling the processor-based system to interpret an acceptance indicator that indicates an offline acceptance of the offer by a user. The third program logic module is for enabling the processor-based system to charge the seller for an amount of the rebate in response to interpretation of the acceptance indicator and for enabling the processor-based system to charge the seller a fee for facilitation of the cross-line conversion of the offer to the offline acceptance. The fourth program logic module is for enabling the processor-based system to credit the amount of the rebate to the user in response to the interpretation of the acceptance indicator.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example advertisement (“ad”) network in accordance with an embodiment described herein.

FIGS. 2-9 depict flowcharts of example methods for processing a cross-line conversion in accordance with embodiments described herein.

FIG. 10 is a block diagram of an example implementation of a cross-line conversion module shown in FIG. 1 in accordance with an embodiment described herein.

FIG. 11 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Example embodiments are capable of processing cross-line conversions. A cross-line conversion occurs when a user performs an offline acceptance of an offer that is associated with an online advertisement. An offline acceptance is an acceptance that is made in-person by the user at a physical location of a seller. Examples of such a physical location include but are not limited to a retail store (e.g., a department store or a boutique store), a fixed or mobile retail stand, a booth at a conference (e.g., a business conference or an academic conference), a kiosk, a sporting arena, a ball park, etc.

In accordance with the example embodiments, an online ad is provided that specifies an offer for a rebate of a portion of a purchase price that is associated with a product and/or service of a seller in return for a purchase of the product and/or service. An indication of an offline acceptance of the offer by a user is received. The seller is charged for an amount of the rebate. The amount of the rebate is credited to the user. A payment is received from the seller as compensation for facilitating a cross-line conversion of the offer to the offline acceptance.

Techniques described herein have a variety of benefits as compared to conventional techniques in which online advertisements are provided to users. For example, by processing cross-line conversions in accordance with techniques described herein, an ad serving system may track the cross-line conversions. A seller may be incentivized to attribute a cross-line conversion to an operator of the ad serving system that provides an offer upon which the cross-line conversion is based. Moreover, the seller may be incentivized to provide information regarding the cross-line conversion to the ad serving system. For instance, the seller may be incentivized based on a contractual obligation of the seller with the operator, awkwardness of denying a user information regarding the cross-line conversion in an account of the user that is designated for automatically storing such information in response to attribution by the seller, the ability of a user to accept a single-use offer multiple times unless the ad serving system is notified that an acceptance has already occurred, the inability of the seller to have a cross-line conversion taken into consideration for targeting advertisements to users (e.g., the present user and/or other users having similar characteristics, such as buying behavior and geolocation, to those of the present user) if the ad serving system is not notified of the cross-line conversion, the inability of the seller to have a user's information (e.g., email address) included in a mailing list of the seller that is maintained by the ad serving system if the seller does not attribute a corresponding cross-line conversion to the ad serving system, reports regarding cross-line conversions likely being less accurate and/or less useful to the seller if the reports do not take into consideration all cross-line conversions with which the seller is involved. The techniques may provide technical means for enabling sellers to attribute cross-line conversions to the operator of the ad serving system. The techniques may be scalable, such that the techniques are usable by relatively small businesses and relatively large businesses. Some techniques may be capable of rendering acceptances of offers invalid for users other than designated user(s).

### II. Example Embodiments

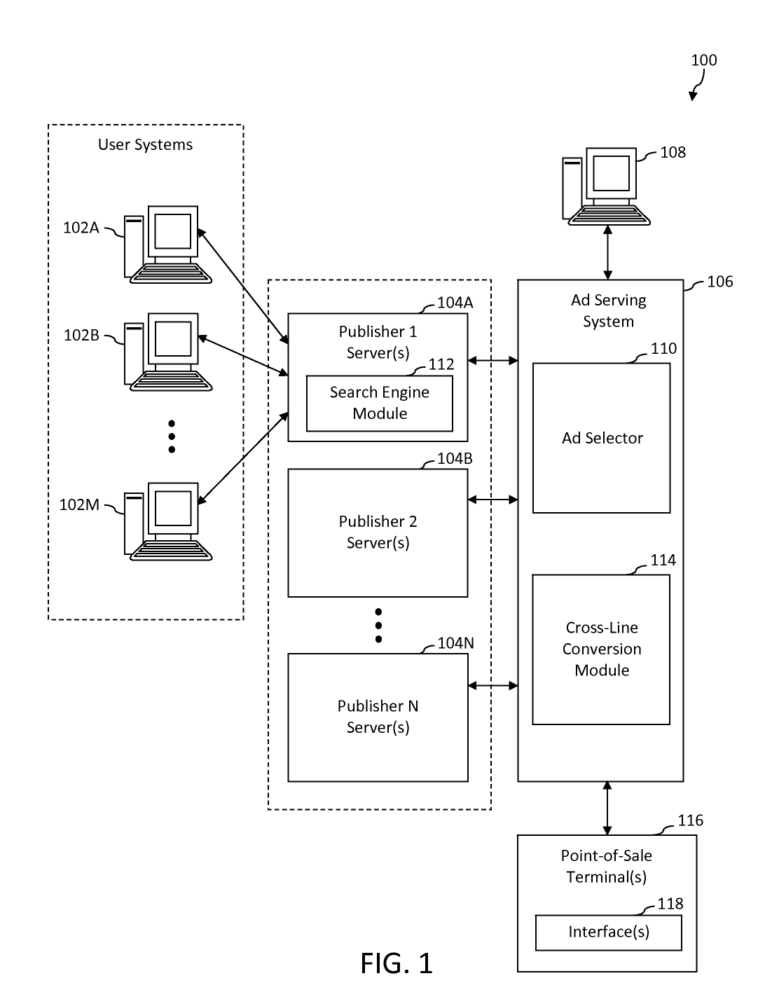

FIG. 1 is a block diagram of an example advertisement (“ad”) network in accordance with an embodiment of the present invention. Generally speaking, ad network 100 operates to serve ads (e.g., contextual ads, sponsored ads, display ads, etc.) provided by advertisers to sites (e.g., Web sites) published by publishers when such sites are accessed by certain users of the network, thereby delivering the ads to the users. Ad network 100 also operates to process cross-line conversions of offers that are included in at least some of the ads. As shown in FIG. 1, ad network 100 includes a plurality of user systems 102A-102M, a plurality of publisher servers 104A-104N, an ad serving system 106, at least one advertiser system 108, and point-of-sale terminal(s) 116. Communication among user systems 102A-102M, publisher servers 104A-104N, ad serving system 106, advertiser system 108, and point-of-sale terminal(s) 116 is carried out over a network using well-known network communication protocols. The network may be a wide area network (e.g., the Internet), a local area network (LAN), another type of network, or a combination thereof.

User systems 102A-102M are computers or other processing systems, each including one or more processors, that are capable of communicating with any one or more of publisher servers 104A-104N. For example, each of user systems 102A-102M may include a client that enables a user who owns (or otherwise has access to) the user system to access sites (e.g., Web sites) that are hosted by publisher servers 104A-104N. In accordance with this example, the clients may enable users to select advertisements that are served with respect to such sites. For instance, a client may be a Web crawler, a Web browser, a non-Web-enabled client, or any other suitable type of client. By way of example, each of user systems 102A-102M is shown in FIG. 1 to be communicatively coupled to publisher 1 server(s) 104A for the purpose of accessing a site published by publisher 1. Persons skilled in the relevant art(s) will recognize that each of user systems 102A-102M is capable of connecting to any of publisher servers 104A-104N for accessing the sites hosted thereon.

Publisher servers 104A-104N are computers or other processing systems, each including one or more processors, that are capable of communicating with user systems 102A-102M. Each of publisher servers 104A-104N is configured to host a site (e.g., a Web site) published by a corresponding publisher 1-N so that such site is accessible to users of network 100 via user systems 102A-102M. Each of publisher servers 104A-104N is further configured to serve advertisements (e.g., contextual ads, sponsored ads, display ads, etc.) to users of network 100 when those users access a site that is hosted by the respective publisher server.

Publisher servers 104A-104N are further configured to execute software programs that provide information to users in response to receiving requests, such as hypertext transfer protocol (HTTP) requests, from users, instant messaging (IM) applications, or Web-based email. For example, the information may include Web pages, images, other types of files, output of executables residing on the publisher servers, IM chat sessions, emails, etc. In accordance with this example, the software programs that are executing on publisher servers 104A-104N may provide Web pages that include interface elements (e.g., buttons, hyperlinks, etc.) that a user may select for accessing the other types of information. The Web pages may be provided as hypertext markup language (HTML) documents and objects (e.g., files) that are linked therein, for example.

One type of software program that may be executed by any one or more of publisher servers 104A-104N is a Web search engine. For instance, publisher 1 server(s) 104A is shown to include search engine module 112, which is configured to execute a Web search engine. Search engine module 112 is capable of searching for information on the World Wide Web (WWW) based on queries that are provided by users. For example, search engine module 112 may search among publisher servers 104A-104N for requested information. Upon discovering instances of information that are relevant to a user's query, search engine module 112 ranks the instances based on their relevance to the query. Search engine module 112 provides a list that includes each of the instances in an order that is based on the respective rankings of the instances. The list may be referred to as the search results corresponding to the query.

Search engine module 112 is configured to provide an ad call to ad serving system 106, upon receiving a query from a user, to request an advertisement (e.g., a contextual ad, a sponsored ad, a display ad, etc.) to be provided to the user. Search engine module 112 forwards a user identifier that corresponds to (e.g., that specifies) the user to ad serving system 106. For example, the user identifier may include a browser cookie of the user or information that is included in the browser cookie. In another example, the user identifier may include a username that is associated with the user. Search engine module 112 may incorporate the user identifier in the ad call or may provide the user identifier in addition to the ad call.

It will be recognized that a search engine module (e.g., search engine module 112) need not necessarily be included in publisher server(s) in order for the publisher server(s) to provide an ad call to ad serving system 106. For instance, any one or more of publisher servers 104A-104N may provide an ad call to ad serving system 106 without utilizing a search engine module.

Ad serving system 106 is a computer or other processing system, including one or more processors, that is capable of serving advertisements (e.g., contextual ads, sponsored ads, display ads, etc.) that are received from advertiser system 108 to each of publisher servers 104A-104N when the sites hosted by such servers are accessed by certain users, thereby facilitating the delivery of such advertisements to the users. For instance, ad serving system 106 may serve advertisement(s) to a publisher server 104 in response to an ad call that is received from that publisher server 104. The ad call may be initiated in response to a query that is provided by a user. Ad serving system 106 may select an appropriate advertisement to be provided to the user based on a user identifier that is received from search engine module 112.

Ad serving system 106 is also capable of determining whether cross-line conversions have occurred with respect to the advertisements that are served by ad serving system 106. When a cross-line conversion occurs, ad serving system 106 processes the cross-line conversion. For instance, ad serving system 106 may handle the transfer of funds between parties that are involved in the cross-line conversion. Such parties may include a seller associated with the advertisement upon which the cross-line conversion is based, the user who performs the offline acceptance of the offer that is included in the advertisement, and ad serving system 106. Transfers of funds may be handled in substantially real-time as cross-line conversions occur or on a periodic basis (e.g., once per hour, once per day, once per week, once every two weeks, once per month, etc.). If transfers are handled on a periodic basis, ad serving system 106 may nevertheless authorize a user to receive funds that are owed to the user earlier than a next scheduled payment period under designated circumstances in response to a corresponding request from the user.

Ad serving system 106 includes an ad selector 110 and a cross-line conversion module 114. Ad selector 110 is configured to select an advertisement (e.g., a contextual ad, a sponsored ad, a display ad, etc.) to be served to a user. Ad selector 110 receives an ad call from a publisher server 104. The ad call requests an advertisement to be displayed to the user. Ad selector 110 receives a user identifier that corresponds to the user from the publisher server 104. The user identifier may be included in the ad call or may be received in addition to the ad call. The user identifier may be associated with information regarding the user. Such information may include, for example, a search history of the user, a browsing history of the user, demographic information (e.g., age, gender, etc.) of the user, interests of the user, etc. Ad selector 110 may use the user identifier and/or the information associated therewith to select the advertisement to be served to the user. Accordingly, an offer may be selected to be specified by the advertisement from a plurality of offers based on the user identifier and/or the information associated therewith.

In one example embodiment, ad serving system 106 stores a look-up table (not shown) that is configured to cross-reference the user identifier and the information regarding the user. Ad selector 110 accesses the look-up table and compares the user identifier with information (e.g., metadata) stored in the look-up table to determine the information regarding the user. Ad selector 110 extracts features from the information regarding the user. Ad selector 110 may assign weights to the extracted features based on various attributes, though the scope of the example embodiments is not limited in this respect. In accordance with this embodiment, ad selector 110 selects the advertisement to be served to the user based on the extracted features. If weights are assigned to the extracted features, ad selector 110 may select the advertisements further based on the weights.

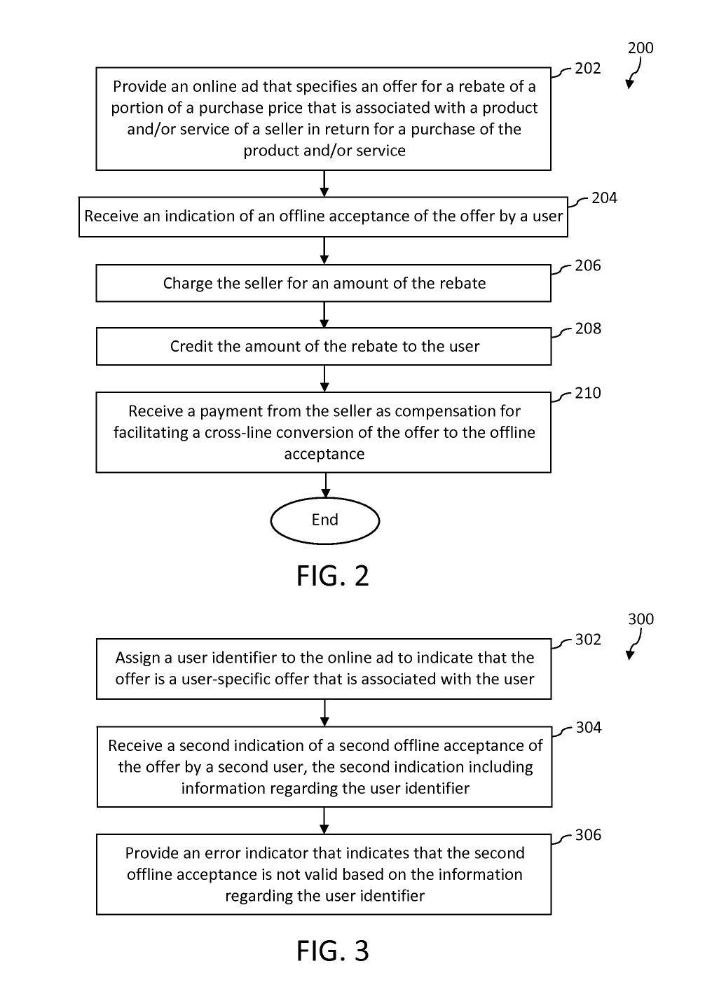

Cross-line conversion module 114 is configured to process cross-line conversions. Cross-line conversion module 114 serves the advertisements that are selected by ad selector 110 to publisher servers 104A-104N in response to the corresponding ad calls that are received by ad selector 110. Any one or more of the advertisements may specify an offer for a rebate from a respective seller. Each rebate corresponds to a portion of a purchase price that is associated with a product and/or service of the respective seller. Cross-line conversion module 114 receives an acceptance indicator from point-of-sale terminal(s) 116 each time a user performs an offline acceptance of an offer that is specified in an online advertisement that is served by cross-line conversion module 114 (e.g., each time a user completes an offline purchase of a product and/or service that is identified in such an offer). Upon receiving each acceptance indicator, cross-line conversion module 114 charges the corresponding seller for an amount of the rebate and credits the amount of the rebate to the user. For each cross-line conversion, cross-line conversion module 114 receives payment from the corresponding seller as compensation for facilitating the cross-line conversion (e.g., for serving the corresponding advertisement to the user). Techniques for processing cross-line conversions are described in further detail below with reference to FIGS. 2-10.

Each of point-of-sale terminal(s) 116 is a computer or other processing system, including one or more processors, that is capable of determining that an offline acceptance of an online offer occurs. For example, a point of sale terminal may be located in a retail store (e.g., a department store or a boutique store), on a fixed or mobile retail stand, in a booth at a conference, in a kiosk, in a sporting arena, in a ball park, etc. Each of point-of-sale terminal(s) 116 is configured to provide an acceptance indicator to cross-line conversion module 114 each time a user performs an offline acceptance of an offer that is specified in an online advertisement that is served by cross-line conversion module 114 at the respective point-of-sale terminal.

Point-of-sale terminal(s) 116 include respective interface(s) 118. Each of interface(s) 118 is configured to detect instances in which users perform offline acceptances of an offer that is specified by an online advertisement at the corresponding point-of-sale. For example, a user may present an online advertisement or an ad indicator (e.g., a barcode, a series of characters, etc.) that is associated with the online advertisement via a mobile device for scanning at an interface. In accordance with this example, the interface may scan the online advertisement or the ad indicator from the mobile device to provide an acceptance indicator to cross-line conversion module 114. The acceptance indicator specifies that the user has performed an offline acceptance of an offer that is specified by the online advertisement. In another example, the user or another individual (e.g., a cashier) may manually enter the indicator at the interface to cause the acceptance indicator to be provided to cross-line conversion module 114.

Advertiser system 108 is a computer or other processing system, including one or more processors, that is capable of providing advertisements (e.g., contextual ads, sponsored ads, display ads, etc.) to ad serving system 106, so that the advertisements may be served to publisher servers 104A-104N when the sites hosted by the respective servers are accessed by certain users. Although one advertiser system 108 is depicted in FIG. 1, persons skilled in the relevant art(s) will recognize that any number of advertiser systems may be communicatively coupled to ad serving system 106.

Although advertiser system 108 and user systems 102A-102M are depicted as desktop computers in FIG. 1, persons skilled in the relevant art(s) will appreciate that advertiser system 108 and user systems 102A-102M may include any browser-enabled system or device, including but not limited to a laptop computer, a tablet computer, a personal digital assistant, a cellular telephone, or the like.

It will be recognized that elements of ad network 100, such as user systems 102A-102M, publisher servers 104A-104N, advertiser system 108, ad selector 110, and cross-line conversion module 114 may perform operations for generating and/or processing online advertisements as described in U.S. patent application Ser. No. 12/710,966, filed Feb. 23, 2010 and entitled “System and Method for Generating Interactive Advertisements,” the entirety of which is incorporated herein by reference in its entirety.

In an example embodiment, sellers and users may have respective accounts that are accessible via a Web service associated with a Web site such as Yahoo!® Deals (accessible at http://deals.yahoo.com), Google Checkout® Deals (accessible at http://www.google.com/checkout/deals.html), MSN® Local Deals (accessible at deals.msn.com), etc. Information regarding the sellers may be stored in respective accounts of the sellers. Information regarding the users may be stored in respective accounts of the users. Ad selector 110 may retrieve the information that is stored in the accounts of the sellers and/or the users to determine advertisements to be served to the users. Cross-line conversion module 114 may retrieve the information that is stored in the accounts of the sellers to determine offers that are available from the sellers, the users who are authorized to accept such offers, the expiration dates and/or times of the offers, etc. Cross-line conversion module 114 may retrieve the information that is stored in the accounts of the users to determine which offers have been selected and/or accepted by the users.

Cross-line conversion module 114 may provide a summary of each cross-line conversion. Each summary may include (or may be based on) retrieved information regarding the user and/or the seller that are associated with the respective cross-line conversion. Cross-line conversion module 114 may store information regarding each summary (e.g., the summary itself or a link thereto) in the account of the user and/or the account of the seller that are associated with the respective cross-line conversion. Each summary may include other information including but not limited to a conversion identifier (ID), time and/or date of the offline acceptance, user's name and/or ID, seller's name and/or ID, product and/or service ID, description of the product and/or service, description of the offer, name of location (e.g., name of store, city, mall, convention center, etc.) at which the offline acceptance occurred, retail value of the product and/or service, amount of rebate, etc.

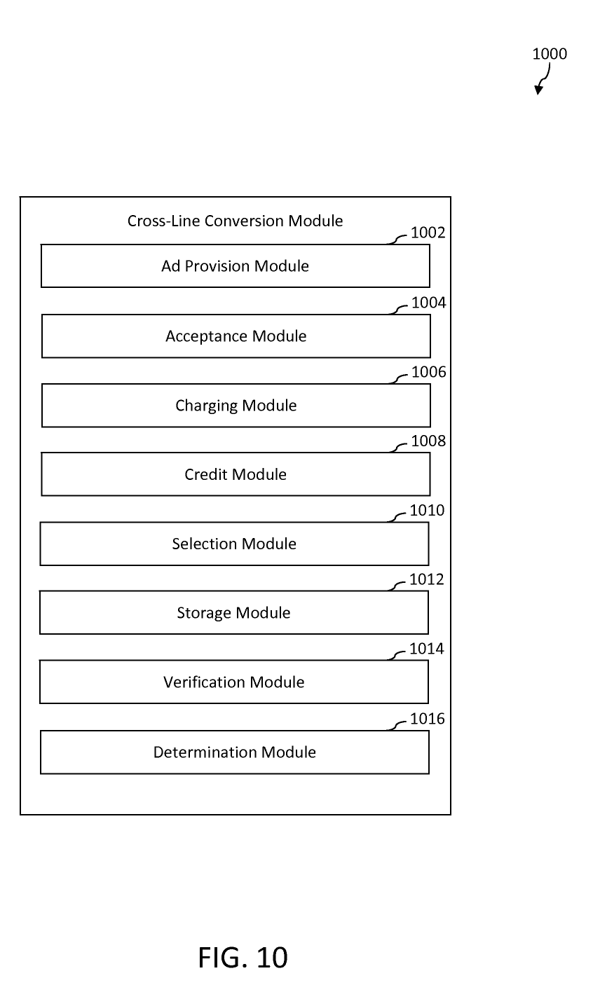

FIGS. 2-9 depict flowcharts 200, 300, 400, 500, 600, 700, 800, and 900 of example methods for processing a cross-line conversion in accordance with embodiments described herein. Flowcharts 200, 300, 400, 500, 600, 700, 800, and 900 may be performed by a cross-line conversion module 114 of ad network 100 shown in FIG. 1, for example. For illustrative purposes, flowcharts 200, 300, 400, 500, 600, 700, 800, and 900 are described with respect to a cross-line conversion module 1000 shown in FIG. 10, which is an example of a cross-line conversion module 114, according to an embodiment. As shown in FIG. 10, cross-line conversion module 1000 includes an ad provision module 1002, an acceptance module 1004, a charging module 1006, a credit module 1008, a selection module 1010, a storage module 1012, a verification module 1014, and a determination module 1016. Further structural and operational embodiments will be apparent to persons skilled in the relevant art(s) based on the discussion regarding flowcharts 200, 300, 400, 500, 600, 700, 800, and 900.

As shown in FIG. 2, the method of flowchart 200 begins at step 202. In step 202, an online ad is provided that specifies an offer. The offer is for a rebate of a portion of a purchase price that is associated with a product and/or service of a seller in return for a purchase of the product and/or service. In an example implementation, ad provision module 1002 provides the online ad that specifies the offer.

At step 204, an indication of an offline acceptance of the offer by a user is received. For example, an ad identifier that is associated with the online ad may be received via an interface that is located at an offline point-of-sale. In accordance with this example, the ad identifier may be included in the indication of the offline acceptance. It will be recognized that the online ad may be provided at step 202 to the user who performs the offline acceptance of the offer at step 204 or to a second user. For instance, if the online ad is provided to the second user at step 202, the second user may share the online ad with the user who then accepts the offer at step 204. In an example implementation, acceptance module 1004 receives the indication of the offline acceptance of the offer by the user.

At step 206, the seller is charged for an amount of the rebate. For example, the seller may be charged in response to authenticating the user and/or the seller. In an example implementation, charging module 1006 charges the seller for the amount of the rebate.

At step 208, the amount of the rebate is credited to the user. For example, the amount of the rebate may be credited to the user in response to authenticating the user and/or the seller. In an example implementation, credit module 1008 credits the amount of the rebate to the user.

At step 210, a payment is received from the seller as compensation for facilitating a cross-line conversion of the offer to the offline acceptance. For instance, the payment may be received in response to charging the seller for an amount of the payment. In an example implementation, charging module 1006 receives the payment from the seller as compensation for facilitating the cross-line conversion.

The amount of the payment that is received from the seller at step 210 may be based on any of a variety of factors including but not limited to an estimated number of impressions, clicks, and/or conversions that are expected to be performed with respect to the offer, an actual number of impressions, clicks, and/or conversions that are performed with respect to the offer, etc. For example, sellers who occupy a specified scale of operation (e.g., reach a specified number of conversions) may be rewarded with a discount on the value of each conversion that is owed by those sellers. For instance, a relatively high number of conversions by a seller may represent a relatively greater reputation of that seller.

Accordingly, the amount of the payment that is received from the seller at step 210 for facilitating the cross-line conversion may be established to be inversely related to a number of offers from the seller that are cross-line converted to offline acceptances. The number of offers may be a running total, a running average, a running median, etc. The number of offers may be a total, average, median, maximum, minimum, etc. number of offers within a specified period of time (e.g., per year, per quarter, per month, per week, per day, within the last year, within the last quarter, within the last month, within the last week, etc.).

In some example embodiments, one or more steps 202, 204, 206, 208, and/or 210 of flowchart 200 may not be performed. Moreover, steps in addition to or in lieu of steps 202, 204, 206, 208, and/or 210 may be performed. For example, FIGS. 3-9 depict flowcharts 300, 400, 500, 600, 700, 800, and 900 that include steps, any one or more of which may be incorporated into flowchart 200.

As shown in FIG. 3, the method of flowchart 300 begins at step 302. In step 302, a user identifier is assigned to the online ad to indicate that the offer is a user-specific offer that is associated with the user. In an example implementation, ad provision module 1002 assigns the user identifier to the online ad.

At step 304, a second indication of a second offline acceptance of the offer by a second user is received. The second indication includes information regarding the user identifier. In an example implementation, acceptance module 1004 receives the second indication of the second offline acceptance of the offer by the second user.

At step 306, an error indicator is provided that indicates that the second offline acceptance is not valid based on the information regarding the user identifier. In an example implementation, acceptance module 1004 provides the error indicator.

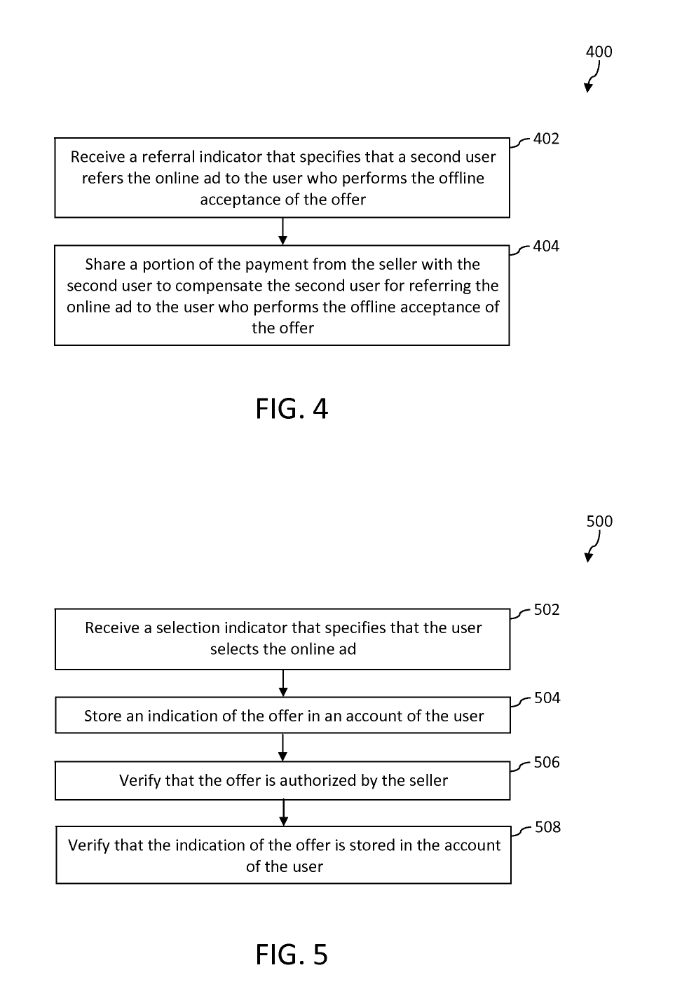

As shown in FIG. 4, the method of flowchart 400 begins at step 402. In step 402, a referral indicator is received that specifies that a second user refers the online ad to the user who performs the offline acceptance of the offer. In an example implementation, acceptance module 1004 receives the referral indicator.

At step 404, a portion of the payment from the seller is shared with the second user to compensate the second user for referring the online ad to the user who performs the offline acceptance of the offer. In an example implementation, credit module 1008 shares the portion of the payment from the seller with the second user.

Some example consumer targeting techniques in which users are paid to share online coupons are provided in U.S. patent application Ser. No. 12/868,571, filed Aug. 25, 2010 and entitled “Targeting Consumers by Paying Users to Share Online Coupons,” the entirety of which is incorporated herein by reference in its entirety. Such consumer targeting techniques may be incorporated into the techniques described herein for processing cross-line conversions.

As shown in FIG. 5, the method of flowchart 500 begins at step 502. In step 502, a selection indicator is received that specifies that the user selects the online ad. In an example implementation, selection module 1010 receives the selection indicator.

At step 504, an indication of the offer is stored in an account of the user. For example, the indication may be automatically stored in the account of the user in response to receiving the selection indicator. In another example, identification information regarding the user may be requested. In accordance with this example, the indication of the offer may be stored in the account of the user in response to receiving the requested identification information. In an example implementation, storage module 1012 stores the indication of the offer in the account of the user.

At step 506, authorization of the offer by the seller is verified. In an example implementation, verification module 1014 verifies that the offer is authorized by the seller.

At step 508, storage of the indication of the offer in the account of the user is verified. In an example implementation, verification module 1014 verifies that the indication of the offer is stored in the account of the user.

In an example embodiment, step 204 of flowchart 200 in FIG. 2 is performed in response to step 502 and/or step 504 of flowchart 500 in FIG. 5. In another example embodiment, step 506 and/or step 508 of flowchart 500 are performed in response to step 204 of flowchart 200. In yet another example embodiment, one or more of steps 206, 208, and 210 of flowchart 200 are performed in response to step 506 and/or step 508 of flowchart 500.

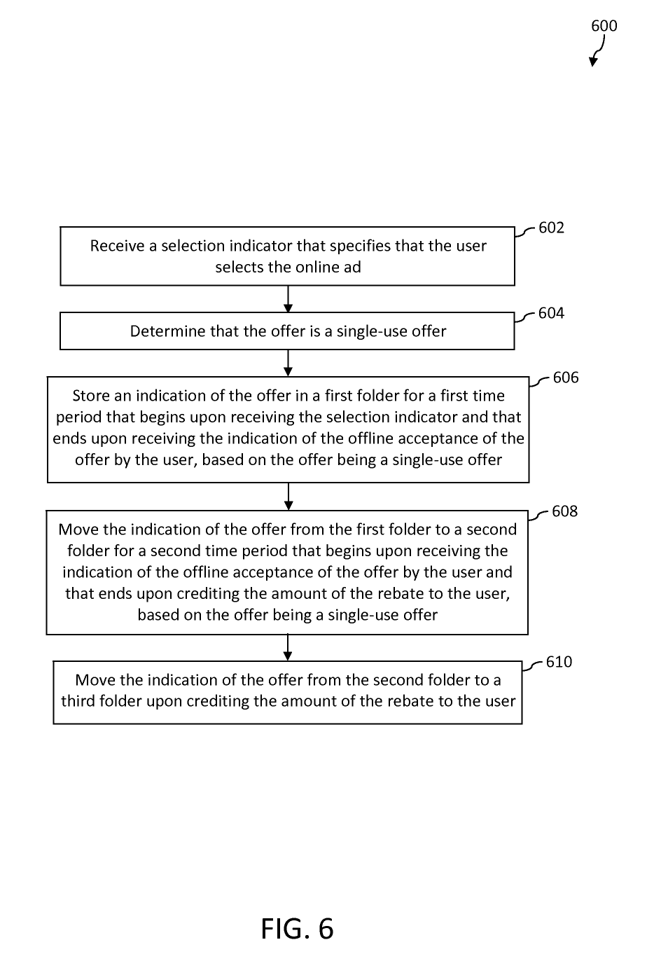

As shown in FIG. 6, the method of flowchart 600 begins at step 602. In step 602, a selection indicator is received that specifies that the user selects the online ad. In an example implementation, selection module 1010 receives the selection indicator.

At step 604, a determination is made that the offer is a single-use offer. A single-use offer is an offer for which only one acceptance is allowed. In an example implementation, determination module 1016 determines that the offer is a single-use offer.

At step 606, an indication of the offer is stored in a first folder for a first time period that begins upon receiving the selection indicator and that ends upon receiving the indication of the offline acceptance of the offer by the user, based on the offer being a single-use offer. In an example implementation, storage module 1012 stores the indication of the offer in the first folder for the first time period.

At step 608, the indication of the offer is moved from the first folder to a second folder for a second time period that begins upon receiving the indication of the offline acceptance of the offer by the user and that ends upon crediting the amount of the rebate to the user, based on the offer being a single-use offer. In an example implementation, storage module 1012 moves the indication of the offer from the first folder to the second folder for the second time period.

At step 610, the indication of the offer is moved from the second folder to a third folder upon crediting the amount of the rebate to the user. In an example implementation, storage module 1012 moves the indication of the offer from the second folder to the third folder upon crediting the amount of the rebate to the user.

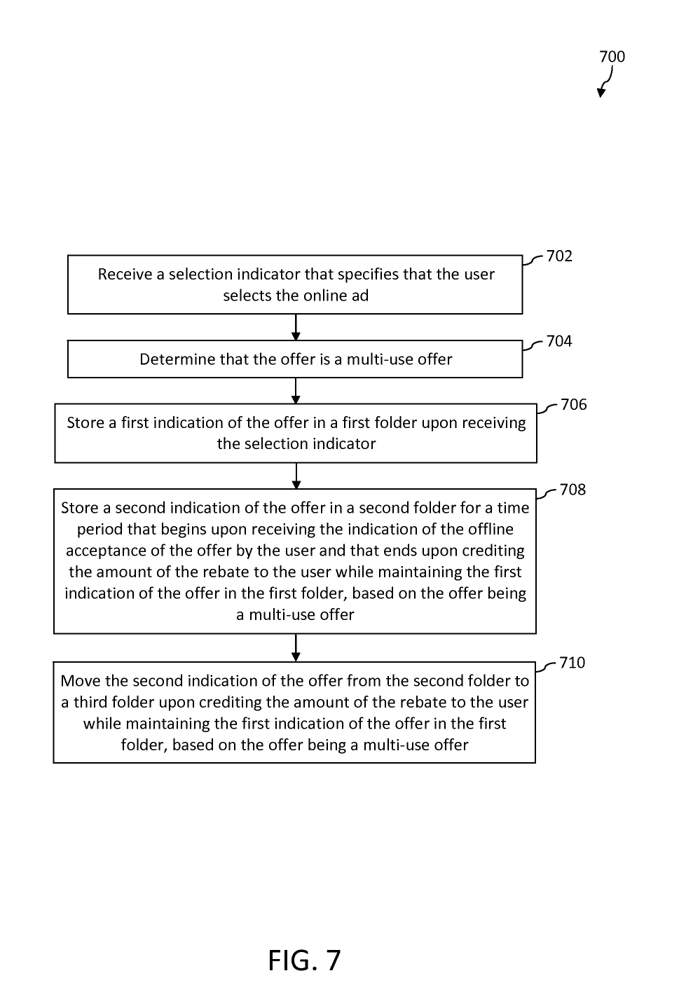

As shown in FIG. 7, the method of flowchart 700 begins at step 702. In step 702, a selection indicator is received that specifies that the user selects the online ad. In an example implementation, selection module 1010 receives the selection indicator.

At step 704, a determination is made that the offer is a multi-use offer. A multi-use offer is an offer for which multiple acceptances are allowed. In an example implementation, determination module 1016 determines that the offer is a multi-use offer.

At step 706, a first indication of the offer is stored in a first folder upon receiving the selection indicator. In an example implementation, storage module 1012 stores the first indication of the offer in the first folder upon receiving the selection indicator.

At step 708, a second indication of the offer is stored in a second folder for a time period that begins upon receiving the indication of the offline acceptance of the offer by the user and that ends upon crediting the amount of the rebate to the user while maintaining the first indication of the offer in the first folder, based on the offer being a multi-use offer. In an example implementation, storage module 1012 stores the second indication of the offer in the second folder for the time period while maintaining the first indication of the offer in the first folder.

At step 710, the second indication of the offer is moved from the second folder to a third folder upon crediting the amount of the rebate to the user while maintaining the first indication of the offer in the first folder, based on the offer being a multi-use offer. In an example implementation, storage module 1012 moves the second indication of the offer from the second folder to the third folder upon crediting the amount of the rebate to the user while maintaining the first indication of the offer in the first folder.

In an example embodiment, the first, second, and third folders described above with reference to steps 606, 608, and 610 of flowchart 600 and steps 706, 708, and 710 of flowchart 700 may be viewable and/or accessible to the user via a Web service associated with a Web site such as Yahoo!® Deals, Google Checkout® Deals, MSN® Local Deals, etc. For instance, the first folder may include representations of offers that are selected by the user, that are not expired, and that are not yet accepted by the user. The second folder may include representations of offers that are selected by the user, that are accepted by the user, and that are not yet entirely processed (e.g., the amount of the corresponding rebate has not yet been charged to the seller, the amount of the corresponding rebate has not yet been credited to the user, and/or the provider of the online ad has not yet been compensated for facilitating the corresponding cross-line conversion). Offers that are selected by the user, that are accepted by the user, and that are not yet entirely processed may be referred to as “pending” offers. The third folder may include representations of offers that are selected by the user, that are accepted by the user, and that are entirely processed (i.e., the amount of the corresponding rebate has been charged to the seller, the amount of the corresponding rebate has been credited to the user, and the provider of the online ad has been compensated for facilitating the corresponding cross-line conversion).

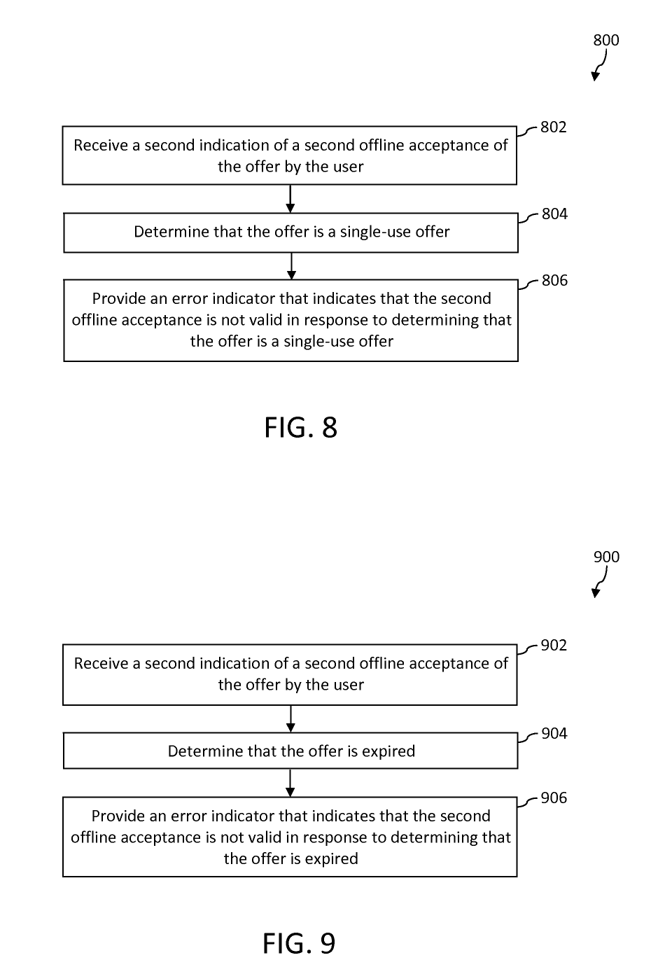

As shown in FIG. 8, the method of flowchart 800 begins at step 802. In step 802, a second indication of a second offline acceptance of the offer by the user is received. In an example implementation, acceptance module 1004 receives the second indication of the second offline acceptance of the offer by the user.

At step 804, a determination is made that the offer is a single-use offer. In an example implementation, determination module 1016 determines that the offer is a single-use offer.

At step 806, an error indicator is provided that indicates that the second offline acceptance is not valid in response to determining that the offer is a single-use offer. Error information may be provided to explain a reason for which the second offline acceptance is not valid and/or to explain actions to take to resolve the issue. In an example implementation, acceptance module 1004 provides the error indicator.

As shown in FIG. 9, the method of flowchart 900 begins at step 902. In step 902, a second indication of a second offline acceptance of the offer by the user is received. In an example implementation, acceptance module 1004 receives the second indication of the second offline acceptance of the offer by the user.

At step 904, a determination is made that the offer is expired. In an example implementation, determination module 1016 determines that the offer is expired.

At step 906, an error indicator is provided that indicates that the second offline acceptance is not valid in response to determining that the offer is expired. Error information may be provided to explain a reason for which the second offline acceptance is not valid and/or to explain actions to take to resolve the issue. In an example implementation, acceptance module 1004 provides the error indicator.

It will be recognized that cross-line conversion module 1000 may not include one or more of ad provision module 1002, acceptance module 1004, charging module 1006, credit module 1008, selection module 1010, storage module 1012, verification module 1014, and/or determination module 1016. Furthermore, cross-line conversion module 1000 may include modules in addition to or in lieu of ad provision module 1002, acceptance module 1004, charging module 1006, credit module 1008, selection module 1010, storage module 1012, verification module 1014, and/or determination module 1016.

### III. Other Example Embodiments

Ad selector 110, search engine module 112, cross-line conversion module 114, point-of-sale terminal(s) 116, interface(s) 118, ad provision module 1002, acceptance module 1004, charging module 1006, credit module 1008, selection module 1010, storage module 1012, verification module 1014, and determination module 1016 may be implemented in hardware, software, firmware, or any combination thereof.

For example, ad selector 110, search engine module 112, cross-line conversion module 114, point-of-sale terminal(s) 116, interface(s) 118, ad provision module 1002, acceptance module 1004, charging module 1006, credit module 1008, selection module 1010, storage module 1012, verification module 1014, and/or determination module 1016 may be implemented as computer program code configured to be executed in one or more processors.

In another example, ad selector 110, search engine module 112, cross-line conversion module 114, point-of-sale terminal(s) 116, interface(s) 118, ad provision module 1002, acceptance module 1004, charging module 1006, credit module 1008, selection module 1010, storage module 1012, verification module 1014, and/or determination module 1016 may be implemented as hardware logic/electrical circuitry.

### IV. Example Computer Implementation

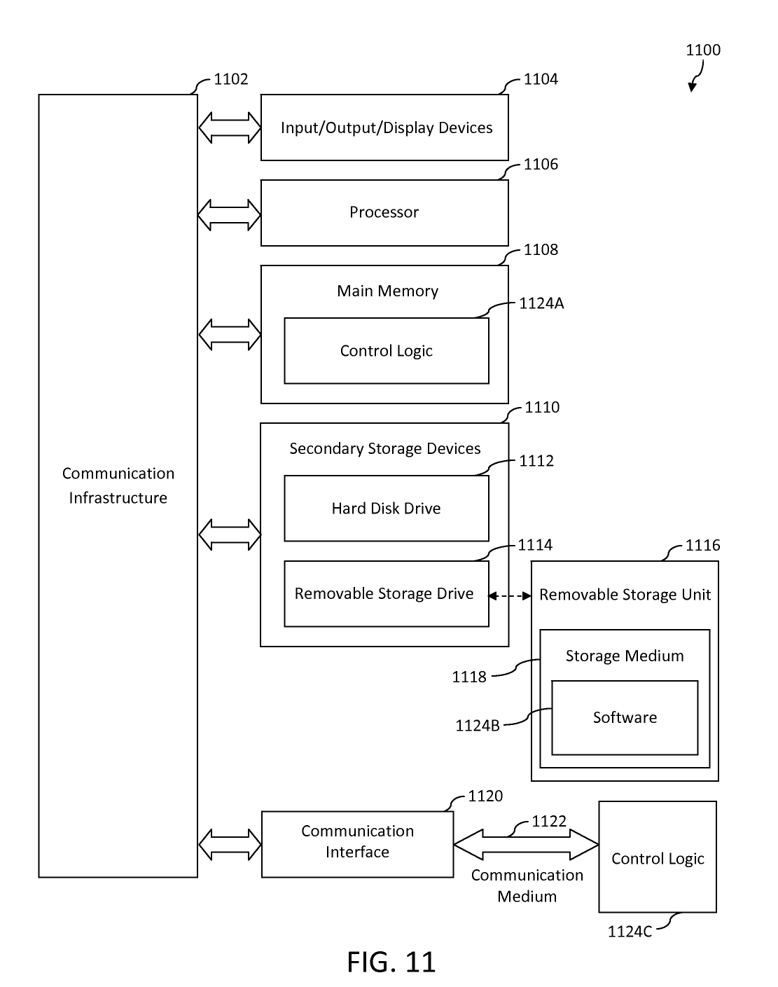

The embodiments described herein, including systems, methods/processes, and/or apparatuses, may be implemented using well known servers/computers, such as computer 1100 shown in FIG. 11. For instance, elements of example ad network 100, including any of the user systems 102A-102M, any of the publisher servers 104A-104N, advertiser system 108, point-of-sale terminal(s) 116, and ad serving system 106 depicted in FIG. 1 and elements thereof, each of the steps of flowchart 200 depicted in FIG. 2, each of the steps of flowchart 300 depicted in FIG. 3, each of the steps of flowchart 400 depicted in FIG. 4, each of the steps of flowchart 500 depicted in FIG. 5, each of the steps of flowchart 600 depicted in FIG. 6, each of the steps of flowchart 700 depicted in FIG. 7, each of the steps of flowchart 800 depicted in FIG. 8, and each of the steps of flowchart 900 depicted in FIG. 9 can each be implemented using one or more computers 1100.

Computer 1100 can be any commercially available and well known computer capable of performing the functions described herein, such as computers available from International Business Machines, Apple, Sun, HP, Dell, Cray, etc. Computer 1100 may be any type of computer, including a desktop computer, a server, etc.

As shown in FIG. 11, computer 1100 includes one or more processors (e.g., central processing units (CPUs)), such as processor 1106. Processor 1106 may include ad selector 110, search engine module 112, and/or cross-line conversion module 114 of FIG. 1; ad provision module 1002, acceptance module 1004, charging module 1006, credit module 1008, selection module 1010, storage module 1012, verification module 1014, and/or determination module 1016 of FIG. 10; or any portion or combination thereof, for example, though the scope of the embodiments is not limited in this respect. Processor 1106 is connected to a communication infrastructure 1102, such as a communication bus. In some embodiments, processor 1106 can simultaneously operate multiple computing threads.

Computer 1100 also includes a primary or main memory 1108, such as a random access memory (RAM). Main memory has stored therein control logic 1124A (computer software), and data.

Computer 1100 also includes one or more secondary storage devices 1110. Secondary storage devices 1110 include, for example, a hard disk drive 1112 and/or a removable storage device or drive 1114, as well as other types of storage devices, such as memory cards and memory sticks. For instance, computer 1100 may include an industry standard interface, such as a universal serial bus (USB) interface for interfacing with devices such as a memory stick. Removable storage drive 1114 represents a floppy disk drive, a magnetic tape drive, a compact disk drive, an optical storage device, tape backup, etc.

Removable storage drive 1114 interacts with a removable storage unit 1116. Removable storage unit 1116 includes a computer useable or readable storage medium 1118 having stored therein computer software 1124B (control logic) and/or data. Removable storage unit 1116 represents a floppy disk, magnetic tape, compact disc (CD), digital versatile disc (DVD), Blue-ray disc, optical storage disk, memory stick, memory card, or any other computer data storage device. Removable storage drive 1114 reads from and/or writes to removable storage unit 1116 in a well known manner.

Computer 1100 also includes input/output/display devices 1104, such as monitors, keyboards, pointing devices, etc.

Computer 1100 further includes a communication or network interface 1120. Communication interface 1120 enables computer 1100 to communicate with remote devices. For example, communication interface 1120 allows computer 1100 to communicate over communication networks or mediums 1122 (representing a form of a computer useable or readable medium), such as local area networks (LANs), wide area networks (WANs), the Internet, etc. Network interface 1120 may interface with remote sites or networks via wired or wireless connections. Examples of communication interface 1122 include but are not limited to a modem, a network interface card (e.g., an Ethernet card), a communication port, a Personal Computer Memory Card International Association (PCMCIA) card, etc.

Control logic 1124C may be transmitted to and from computer 1100 via the communication medium 1122.

Any apparatus or manufacture comprising a computer useable or readable medium having control logic (software) stored therein is referred to herein as a computer program product or program storage device. This includes, but is not limited to, computer 1100, main memory 1108, secondary storage devices 1110, and removable storage unit 1116. Such computer program products, having control logic stored therein that, when executed by one or more data processing devices, cause such data processing devices to operate as described herein, represent embodiments of the invention.

For example, each of the elements of example ad selector 110, search engine module 112, and cross-line conversion module 114, each depicted in FIG. 1; ad provision module 1002, acceptance module 1004, charging module 1006, credit module 1008, selection module 1010, storage module 1012, verification module 1014, and determination module 1016, each depicted in FIG. 10; each of the steps of flowchart 200 depicted in FIG. 2; each of the steps of flowchart 300 depicted in FIG. 3; each of the steps of flowchart 400 depicted in FIG. 4; each of the steps of flowchart 500 depicted in FIG. 5; each of the steps of flowchart 600 depicted in FIG. 6; each of the steps of flowchart 700 depicted in FIG. 7; each of the steps of flowchart 800 depicted in FIG. 8; and each of the steps of flowchart 900 depicted in FIG. 9 can be implemented as control logic that may be stored on a computer useable medium or computer readable medium, which can be executed by one or more processors to operate as described herein.

### V. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method comprising:
providing an online ad that specifies an offer for a rebate of a portion of a purchase price that is associated with at least one of a product or a service of a seller in return for a purchase of the at least one of the product or the service;
receiving an indication of an offline acceptance of the offer by a user;
charging the seller for an amount of the rebate in response to receiving the indication of the offline acceptance;
crediting the amount of the rebate to the user in response to receiving the indication of the offline acceptance; and
receiving a payment from the seller as compensation for facilitating a cross-line conversion of the offer to the offline acceptance.

2. The method of claim 1, wherein receiving the indication of the offline acceptance comprises:
receiving an ad identifier that is associated with the ad via an interface that is located at an offline point-of-sale, the ad identifier being included in the indication of the offline acceptance.

3. The method of claim 1, wherein providing the online ad comprises:
providing the online ad to specify the offer for the user, the offer offering the rebate in return for the user purchasing the at least one of the product or the service;
wherein the method further comprises:
assigning a user identifier to the online ad to indicate that the offer is a user-specific offer that is associated with the user;
receiving a second indication of a second offline acceptance of the offer by a second user, the second indication including information regarding the user identifier; and
providing an error indicator that indicates that the second offline acceptance is not valid based on the information regarding the user identifier.

4. The method of claim 1, wherein providing the online ad comprises:
providing the online ad to specify the offer for a second user; and
wherein the method further comprises:
receiving a referral indicator that specifies that the second user refers the online ad to the user who performs the offline acceptance of the offer; and
sharing a portion of the payment from the seller with the second user to compensate the second user for referring the online ad to the user who performs the offline acceptance of the offer.

5. The method of claim 1, further comprising:
establishing an amount of the payment from the seller to be inversely related to a number of offers from the seller that are cross-line converted to offline acceptances.

6. The method of claim 1, further comprising:
receiving a selection indicator that specifies that the user selects the online ad;
storing an indication of the offer in an account of the user in response to receiving the selection indicator;
verifying that the offer is authorized by the seller in response to receiving the indication of the offline acceptance of the offer by the user; and
verifying that the indication of the offer is stored in the account of the user in response to receiving the indication of the offline acceptance of the offer by the user;
wherein charging the seller for the amount of the rebate comprises:
charging the seller for the amount of the rebate further in response to verifying that the offer is authorized by the seller and further in response to verifying that the indication of the offer is stored in the account of the user; and
wherein crediting the amount of the rebate to the user comprises:
crediting the amount of the rebate to the user further in response to verifying that the offer is authorized by the seller and further in response to verifying that the indication of the offer is stored in the account of the user.

7. The method of claim 1, further comprising:
receiving a selection indicator that specifies that the user selects the online ad;
determining that the offer is a single-use offer;
storing an indication of the offer in a first folder for a first time period that begins upon receiving the selection indicator and that ends upon receiving the indication of the offline acceptance of the offer by the user, based on the offer being a single-use offer;
moving the indication of the offer from the first folder to a second folder for a second time period that begins upon receiving the indication of the offline acceptance of the offer by the user and that ends upon crediting the amount of the rebate to the user, based on the offer being a single-use offer; and
moving the indication of the offer from the second folder to a third folder upon crediting the amount of the rebate to the user.

8. The method of claim 1, further comprising:
receiving a selection indicator that specifies that the user selects the online ad;
determining that the offer is a multi-use offer;
storing a first indication of the offer in a first folder upon receiving the selection indicator;
storing a second indication of the offer in a second folder for a time period that begins upon receiving the indication of the offline acceptance of the offer by the user and that ends upon crediting the amount of the rebate to the user while maintaining the first indication of the offer in the first folder, based on the offer being a multi-use offer; and
moving the second indication of the offer from the second folder to a third folder upon crediting the amount of the rebate to the user while maintaining the first indication of the offer in the first folder, based on the offer being a multi-use offer.

9. The method of claim 1, further comprising:
receiving a second indication of a second offline acceptance of the offer by the user;
determining that the offer is a single-use offer; and
providing an error indicator that indicates that the second offline acceptance is not valid in response to determining that the offer is a single-use offer.

10. The method of claim 1, further comprising:
receiving a second indication of a second offline acceptance of the offer by the user;
determining that the offer is expired; and
providing an error indicator that indicates that the second offline acceptance is not valid in response to determining that the offer is expired.

11. A system comprising:
an ad provision module configured to provide an online ad that specifies an offer for a rebate of a portion of a purchase price that is associated with at least one of a product or a service of a seller in return for a purchase of the at least one of the product or the service;
an acceptance module configured to interpret an acceptance indicator that indicates an offline acceptance of the offer by a user;
a charging module configured to charge the seller for an amount of the rebate in response to interpretation of the acceptance indicator, the charging module further configured to charge the seller a fee for facilitation of a cross-line conversion of the offer to the offline acceptance;
a credit module configured to credit the amount of the rebate to the user in response to the interpretation of the acceptance indicator.

12. The system of claim 1, wherein the ad provision module is configured to provide the online ad to specify the offer for the user, the offer offering the rebate in return for the user purchasing the at least one of the product or the service;
wherein the ad provision module is further configured to assign a user identifier to the online ad to indicate that the offer is a user-specific offer that is associated with the user; and
wherein the acceptance module is further configured to provide an error indicator that indicates that a second acceptance indicator that indicates a second offline acceptance of the offer by a second user is not valid based on information regarding the user identifier, the information being included in the second acceptance indicator.

13. The system of claim 1, wherein the ad provision module is configured to provide the online ad to specify the offer for a second user;
wherein the acceptance module is further configured to interpret a referral indicator that specifies that the second user refers the online ad to the user who performs the offline acceptance of the offer; and
wherein the credit module is further configured to credit a portion of the fee from the seller to the second user to compensate the second user for referral of the online ad to the user who performs the offline acceptance of the offer.

14. The system of claim 1, wherein an amount of the fee from the seller for facilitation of the cross-line conversion of the offer to the offline acceptance is inversely related to a number of offers from the seller that are cross-line converted to offline acceptances.

15. The system of claim 1, further comprising:
a selection module configured to interpret a selection indicator that specifies that the user selects the online ad;
a storage module configured to store an indication of the offer in an account of the user based on the selection indicator;
a verification module configured to verify that the offer is authorized by the seller in response to receipt of the indication of the acceptance indicator, the verification module further configured to verify that the indication of the offer is stored in the account of the user in response to receipt of the acceptance indicator;
wherein the charging module is configured to charge the seller for the amount of the rebate further in response to verification that the offer is authorized by the seller and further in response to verification that the indication of the offer is stored in the account of the user; and
wherein the credit module is configured to credit the amount of the rebate to the user further in response to verification that the offer is authorized by the seller and further in response to verification that the indication of the offer is stored in the account of the user.

16. The system of claim 1, further comprising:
a selection module configured to interpret a selection indicator that specifies that the user selects the online ad;
a determination module configured to determine that the offer is a single-use offer; and
a storage module configured to store an indication of the offer in a first folder for a first time period that begins upon receipt of the selection indicator and that ends upon receipt of the acceptance indicator, based on the offer being a single-use offer;
the storage module further configured to move the indication of the offer from the first folder to a second folder for a second time period that begins upon receipt of the acceptance indicator and that ends upon the amount of the rebate being credited to the user, based on the offer being a single-use offer; and
the storage module further configured to move the indication of the offer from the second folder to a third folder upon the amount of the rebate being credited to the user.

17. The system of claim 1, further comprising:
a selection module configured to interpret a selection indicator that specifies that the user selects the online ad;
a determination module configured to determine that the offer is a multi-use offer; and
a storage module configured to store a first indication of the offer in a first folder upon receipt of the selection indicator;
the storage module further configured to store a second indication of the offer in a second folder for a time period that begins upon receipt of the acceptance indicator and that ends upon the amount of the rebate being credited to the user while the first indication of the offer continues to be stored in the first folder, based on the offer being a multi-use offer; and
the storage module further configured to move the second indication of the offer from the second folder to a third folder upon the amount of the rebate being credited to the user while the first indication of the offer continues to be stored in the first folder, based on the offer being a multi-use offer.

18. The system of claim 1, wherein the acceptance module is further configured to interpret a second acceptance indicator that indicates a second offline acceptance of the offer by the user; and
wherein the system further comprises:
a determination module configured to determine that the offer is a single-use offer; and
wherein the acceptance module is further configured to provide an error indicator that indicates that the second offline acceptance is not valid in response to determination that the offer is a single-use offer.

19. The system of claim 1, wherein the acceptance module is further configured to interpret a second acceptance indicator that indicates a second offline acceptance of the offer by the user; and
wherein the system further comprises:
a determination module configured to determine that the offer is expired; and
wherein the acceptance module is further configured to provide an error indicator that indicates that the second offline acceptance is not valid in response to determination that the offer is expired.

20. A computer program product comprising a computer-readable medium having computer program logic recorded thereon for enabling a processor-based system to perform processing with regard to a cross-line conversion, the computer program product comprising:
a first program logic module for enabling the processor-based system to provide an online ad that specifies an offer for a rebate of a portion of a purchase price that is associated with at least one of a product or a service of a seller in return for a purchase of the at least one of the product or the service;
a second program logic module for enabling the processor-based system to interpret an acceptance indicator that indicates an offline acceptance of the offer by a user;
a third program logic module for enabling the processor-based system to charge the seller for an amount of the rebate in response to interpretation of the acceptance indicator and for enabling the processor-based system to charge the seller a fee for facilitation of the cross-line conversion of the offer to the offline acceptance;
a fourth program logic module for enabling the processor-based system to credit the amount of the rebate to the user in response to the interpretation of the acceptance indicator.
